(19) United States
(12) Patent Application Publication
(10) Pub. No.: US 2003/0222755 A1
(43) Pub. Date: Dec. 4, 2003

(54) Credit card sized remote control transmitter application

(76) Inventors: Jonathan Thomas Kemper, San Diego, CA (US); Mark Edward Rutledge, Murrieta, CA (US); Jerry Wayne Birchfield, Vista, CA (US)

Correspondence Address: Directed Electronics, Inc., One Viper Way, Vista, CA, 92083, US

(21) Appl. No.: 10/163,896

(22) Filed: May 31, 2002

(51) Int. Cl. G05B 19/00

(52) U.S. Cl. 340/5.61; 340/5.73

(57) ABSTRACT

A credit card sized remote control transmitter comprising a complete independent remote control transmitter with an internal power supply, user operable switches, a system security encoder circuit, a transmitting circuit, an antenna, and printed circuit board combined into a transmitter embedded into a card that is the size of a normal credit card or smaller and thin enough to be easily and conveniently stored and carried in a user's wallet, purse, or garment pocket. The transmitter can be easily, conveniently, and comfortably stored and carried as an emergency or convenience remote control transmitter in case the primary remote control transmitter fails, is lost, is misplaced, or is inaccessibly locked inside the vehicle. Additionally, the transmitter optionally comprises a mechanical key for any emergency or convenience operation of any locking mechanism. When any key is to be used to operate the ignition and starting circuits of a vehicle, the transmitter with or without the key optionally comprises a complete transponder unit that is programmable into the passive interrupt system of a vehicle to enable the starting and running of a vehicle containing a passive interrupt system. The transmitter can also have contacts for charging the internal battery.

### BACKGROUND OF THE INVENTION

1. Field of the Invention

The present invention relates generally to a remote controlled keyless entry system, a remote controlled security system, a remote controlled vehicle starting system, or some other remote controlled system. More specifically, the invention relates to a complete remote control transmitter that is built into the form and size of a credit card for conveniently storing in a credit card holder in a wallet, a purse, or a garment pocket when not in use. This credit card sized device in addition to containing a remote control transmitter may also include a mechanical key for a tumbler type or other locking mechanism built into the credit card sized, which can be used for entry purposes, to operate the ignition and starting circuits of a vehicle, or for any other purpose that is related to a remote controlled system. When used to operate the ignition and starting circuits of a vehicle, the device can also include a transponder that can be programmed into the vehicle to allow operation of the vehicle ignition and starting circuits. The transmitter can also have contacts for charging the internal battery.

2. Description of the Prior Art

Remote control transmitters have been in use since the 1970's for remote control of televisions and radios. Most of the first remote control transmitters that were found in the prior art, used ultrasonic transducers for the transmission and reception of control signals. A few of the ultrasonic transducer patents are U.S. Pat. Nos. 3,944,982; 3,949,297; 3,971,986; 3,988,701; and 4,021,756. Ultrasonic transducers are not practical for use in remote control applications where you must penetrate a sealed environment, since the ultrasonic signals have difficulty penetrating solid objects such as, but not limited to doors, windows, and walls. The earliest RF (radio frequency) remote control transmitter that was found in the search is U.S. Pat. No. 4,041,394. This remote control transmitter was built into a vest-like garment and is not acceptable at all, in today's advanced remote controlled security market. The RF remote control transmitter disclosed in this patent used the operating frequency and time only to operate the remote controlled device. This was good for its time, but it is totally unacceptable in today's intense and often saturated RF environment. There can be many random false operations of any system containing such a system of operation in today's severe RF environment. Remote control transmitters have increased substantially in capabilities, while decreasing in size dramatically. Today, there are frequency hopping spread spectrum remote control transmitters with code hopping capabilities.

There are keyless entry and security systems using transponders with built in “RF transmitters” that are built in to name-card or credit-card size packages that can be stored in a garment pocket as shown in U.S. Pat. Nos. 4,719,460 and 5,134,392. These transponder transmitters depend completely on their internal microcontrollers, memory, and a control signal and power from the controlling transceiver in the vehicle to operate the transmitter. If there is a user operable switch, it is connected directly to the controlling transceiver in the vehicle. Essentially they are different from the instant invention in that user activated operation of system features is not possible from the remote transmitter without being in direct contact with the vehicle. All functional operation is dependent on the system microcontroller providing memory, power and a control signal to the remote. In fact, they are not known in the remote control industry as remote control transmitters, but as transponders that are passive devices that operate when a user approaches the vehicle or activates from the controlling transceiver located in the vehicle by activating the switch attached thereto as shown in U.S. Pat. No. 4,719,460. For example, some of these systems have the transponder in the key and operate when and only when the key is inserted into the ignition. Operation is initiated by power that is transmitted from a wire loop around the ignition key slot. None of these transmitters having credit card size and thickness independently function as a remote transmitter with its own power source.

Another “thin” remote control transmitter is discussed in U.S. Pat. No. 4,963,876. This remote control transmitter is approximately 0.3 inches (7.62 mm) thick and is a very thin transmitter, when compared with most remote control transmitters. This is a “thin”, complete remote control transmitter that does not depend on a control signal from the remote control system. It is designed to be attached to a key chain with a set of keys, and to be carried in a garment pocket or purse, but it is too thick to store conveniently in a wallet. Even at its minimum thickness, this independent transmitter will not properly fit in a credit card holder. There are additional limitations in that if the transmitter is misplaced or lost the user will be without any method of entry to the vehicle or the capability to start and operate the vehicle. The current invention overcomes this limitation.

Plastic keys embedded in a credit card sized package are disclosed in U.S. Pat. Nos. 4,637,236 and 4,677,835, which are incorporated herein by reference. In these patents, plastic key blanks can lie flat in the recess of a credit-card size device and they can be hinged out to a position perpendicular to the plane of the card for keying and use. The hinge disclosed in U.S. Pat. No. 4,677,835 also allows the plastic key to twist slightly without damaging the circular plastic hinge. The thickness of the plastic credit card device that contains these keys is approximately 1.6 millimeters thick and the thickness of the plastic key carried in this holder is approximately 3 millimeters thick, which is approximately ⅛ inch thick. The devices of the '236 and the '835 patent are limited in that the can neither provide a remote control transmitter signal nor do they contain a transponder device to overcome factory passive antitheft protection systems.

The card key with a transmitter element as disclosed in U.S. Pat. No. 6,050,118 is a card key for operating the ignition, start, and operating circuits of a vehicle wherein the card holder for the key also contains a complete transponder unit. The transponder is referred to continually as a transmitter, but it is a transponder that draws its power and is completely controlled by the vehicle passive antitheft protection system. The transponder allows the starting and operating of a vehicle with a passive antitheft protection system. There are no user operable switches that allow the user to operate the transponder “transmitter.” Therefore this device falls short of the instant invention in that user operable switches that allow the user to operate the credit card sized remote control transmitter from a much greater distance than the above mentioned transponder “transmitter.”

The prior art fails to provide a remote control transmitter that is fully integrated, user operable and that has a size and thickness that enables it to fit into a credit card holder in a wallet or purse. There is a need in the art for a transmitter of credit card size that has its own independent power source and is still thin enough to fit in a wallet or credit card holder. There is a special need for a user operable transmitter of this small size and thickness in order to provide a convenient back-up transmitter in case a primary transmitter fails, is lost, misplaced, or inaccessibly locked inside the vehicle. There is an additional need to provide an additional back-up means of entry in the form of a mechanical key carried in a recess of the credit card sized transmitter.

Therefore, it is an object of this invention to provide a complete remote control transmitter with an internal power supply (battery), user activated switches, system security encoder, radio frequency (RF) transmitting circuit that is composed of an oscillator circuit and a driver circuit, printed circuit board, and antenna that when encapsulated is built into a card format that is the size of a normal credit card and of a thickness that is easily stored in a user's wallet.

Furthermore, it is an object of this invention to provide a remote control credit card sized transmitter for increased convenience and reliability through the redundancy of a back-up transmitter.

It is yet a further object of the current invention to provide a credit card sized transmitter with a mechanical key and transponder device to allow vehicle starting and operating when the vehicle has a factory installed passive antitheft device.

It is another object of the present invention to provide a means to recharge the credit card sized transmitter to extend the useful life of the transmitter.

It is further an object of the invention to provide a fully functional credit card sized transmitter that is essentially water proof so that if the transmitter is submerged in water, it will still operate upon removal from the water. The instant invention provides a credit card sized remote control transmitter that can be carried in a pocket while the user is swimming, surfing, snorkeling, or scuba diving and the primary remote control transmitter, wallet, and other personal belongings are inaccessibly locked in the vehicle.

Still, yet another object of the invention is to provide a credit card sized remote control transmitter with or without a key and/or transponder that can be stored in a convenient location that is easy to remember, and readily accessible to the user such as a wallet, purse, or garment pocket.

The instant invention solves these problems and meets these objectives as set forth below.

### BRIEF SUMMARY OF THE INVENTION

The credit card sized remote control transmitter of the instant invention has a complete remote control transmitter with an internal power supply (battery), one or more user activated switches, a system security encoder, a radio frequency (RF) transmitting circuit composed of an oscillator circuit and a driver circuit, a transponder unit, an antenna, and a printed circuit board that is built into a card format that when encapsulated is the size of a normal credit card and of a thickness that is easily and conveniently stored in a user's wallet, purse, or garment pocket.

This is accomplished by the main aspects of the invention. One aspect of the invention is that the credit card sized transmitter has electronic circuitry and components of an overall size that can reside within the dimensions of a regular credit card. The current invention is fully self contained and functional for purposes of maintaining redundancy for entry, arming and disarming of a security system, or remotely starting a vehicle in the event that a remote control transmitter, a key or both, fails, are misplaced, lost, stolen, or are inaccessibly locked inside the vehicle. The credit card sized remote control transmitter of the instant invention can act as a secondary transmitter when the primary transmitter is lost or misplaced. Since the remote control credit card sized transmitter is easily and comfortably placed in a credit card holder of a wallet, purse, or in a garment pocket, the redundancy does not become inconvenient and does not take up too much space. Since the credit card sized remote control transmitter is very thin it can be comfortably carried in a wallet or garment pocket.

Alternatively, the credit card sized remote control transmitter may be used as a loaner. That is, it can be loaned to someone that only needs it temporarily. A good example of this would be in a rental car or in a company vehicle used by more than one individual. In these cases, inadvertent loss of or carrying off of the credit card sized transmitter will not be a big problem.

Yet, another object of this invention is to provide further convenience to the user by providing a mechanical key to use in any emergency or as a convenience with any tumbler or other type locking mechanism associated with or not associated with the remote control system. The credit card sized remote control transmitter package additionally comprising a flexibly hinged mechanical key, a key-shaped recessed opening in the credit card material for storing said flexibly hinged mechanical key, and said mechanical key flexibly hinging outwardly to an angle perpendicular to the plane of the card for keying and use, the key adapted for any conventional mechanical locking mechanism use, such as, but not limited to the operation of the ignition and starting circuits of a vehicle, or for any other locking mechanism purpose. When a plain key is to be used to operate the ignition and starting circuits of a vehicle, the credit card sized remote control transmitter with or without the key optionally comprises a complete transponder unit that is programmable into the passive interrupt system of the vehicle to enable the starting and running of a vehicle with said passive interrupt system. Additionally, the disclosed credit card sized remote control is manufactured to be essentially waterproof so that a user can rest assured that any exposure to water will not damage the circuitry of the device nor limit its functionality. The instant invention provides a credit card sized remote control transmitter that could be carried in a pocket while the user is swimming, surfing, snorkeling, or scuba diving and the primary remote control transmitter, wallet, and other personal belongings are inaccessibly locked in the vehicle. This is possible since the credit card sized remote control transmitter is essentially waterproof and can be easily and conveniently stored and carried in a swim suit pocket. Additionally, for this application in particular, as well as other applications, there is a use for the credit card sized remote control transmitter to contain a complete transponder unit, that when programmed into the vehicle passive interrupt system, enables the passive interrupt system allowing the starting and running of the vehicle using a plain ignition key.

The present invention also includes a means for recharging the built in power source so the useful life of the device can be extended.

While the apparatus has or will be described for the sake of grammatical fluidity with functional explanations, it is to be expressly understood that the claims, unless expressly formulated under 35 USC 112, are not to be construed as necessarily limited in any way by the construction of “means” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

FIG. 1A is a plan view of a first embodiment of the credit card sized remote control transmitter of the instant invention.

FIG. 1B is an end elevation view of the credit card sized remote control transmitter of FIG. 1.

FIG. 1C is a side elevation view of the credit card sized remote control transmitter of FIG. 1.

FIG. 2A is a plan view of a second embodiment of the credit card sized remote control transmitter that includes a key blank located in the card.

FIG. 2B is a side elevation view of the credit card sized remote control transmitter of FIG. 2.

FIG. 2C is an end elevation view of the credit card sized remote control transmitter of FIG. 2.

FIG. 3 is a block diagram of a first embodiment of typical 2 channel remote control transmitter electronics circuitry that can be built into a credit card sized.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE PREFERRED EMBODIMENTS

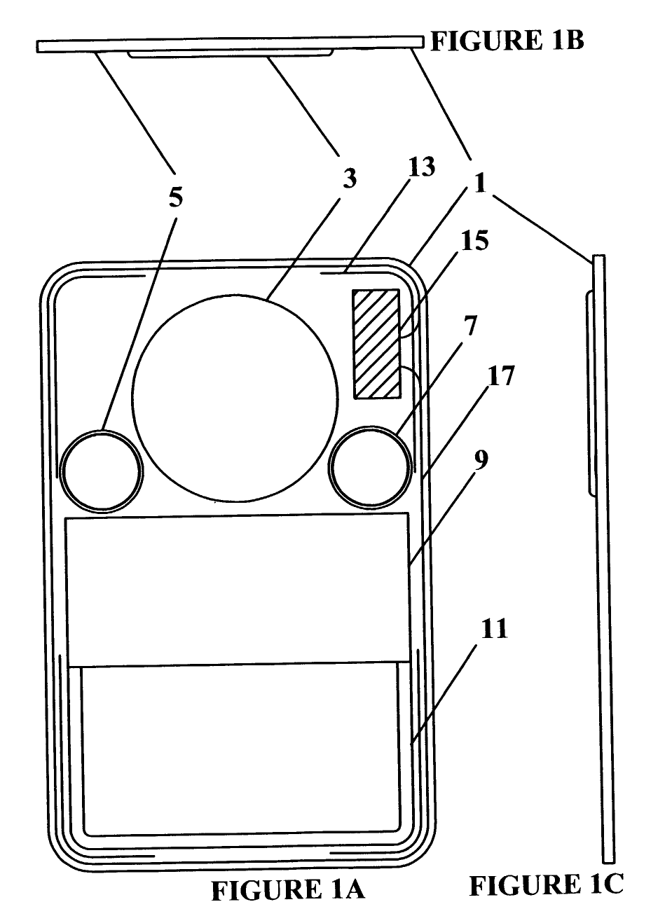

In FIGS. 1A-1C shows the credit card sized remote control transmitter 1 of the preferred embodiment is integrated into plastic credit card sized casing that incorporates and encloses each of the elements of the entire device using any well known laminating, potting, encapsulating or coating process and material. The term encapsulation, hereafter, is used to identify any process that encloses all the elements of the transmitter. In the preferred embodiment, the material used for encapsulation of credit card sized remote control transmitter, 1, is a plastic compound. The encapsulation, laminate or coating allows for an essentially waterproof device. The transmitter 1 can also be made without the laminate or coating but may not be waterproof. The casing which essentially encapsulates and encloses the transmitter as a unitary device can contain any type of remote control RF transmitter frequency control elements such as, but not limited to a LC (inductor, capacitor), a SAW (surface acoustically wave) resonator, a crystal controlled, or a balanced oscillator, each of which is well known in the art. In the preferred embodiment the RF transmitter frequency control element is located in the electronic circuitry section 9 of the transmitter 1 and 21.

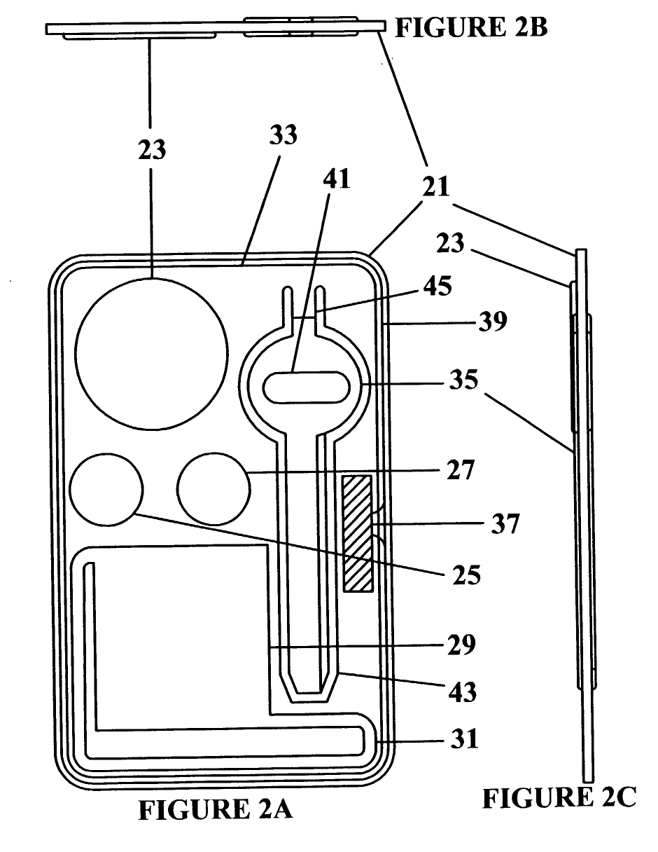

FIGS. 1A-1C and 2A-2C are not drawn to size, but the proportions are scaled to be essentially the same as a standard plastic credit card. Most of the elements of the remote control transmitter are completely embedded and encapsulated in the plastic encapsulation material. The only operational components of the transmitter that must be accessibly to the user are the user operable switches and these can be covered by a thin coating of the encapsulation material as long as covering remains flexible enough for the user to activate the switches. Even the battery can be completely embedded and encapsulated in the plastic card encapsulation material since the credit card sized remote control transmitter is normally used infrequently.

FIGS. 1A-1C are drawings of a first embodiment of the credit card sized remote control transmitter 1 without a plastic key built into the transmitter. FIGS. 1A-1C shows all the internal sections of the transmitter 1. In the preferred embodiment, the credit card sized remote control transmitter without a key could be essentially the same size as a normal credit card (2⅛″ by 3⅜″) and of a thickness that is less than, equal to, or slightly greater than a normal credit card. The thickness of any location on the credit card sized remote control transmitter is not greater than ⅛″. For any embodiment of transmitter, 1, the width of the credit card transmitter without a key is not less than 1″ or greater than 3″ and the length of the credit card transmitter without a key is not less than 2″ or greater than 5″.

The battery section 3 is shown as a raised section of the transmitter where a thicker lithium battery could be installed. In the preferred embodiment a thinner lithium battery is used and the battery section is not raised. A printed battery could also be used and built into a printed circuit board or into the interior of the encapsulated surface of the transmitter 1. A printed battery is a battery that is printed on a printed circuit board or paper as a normal printing process using printable chemicals to create a battery that is very thin. Also, any other thin battery or power source with sufficient capacity could be used.

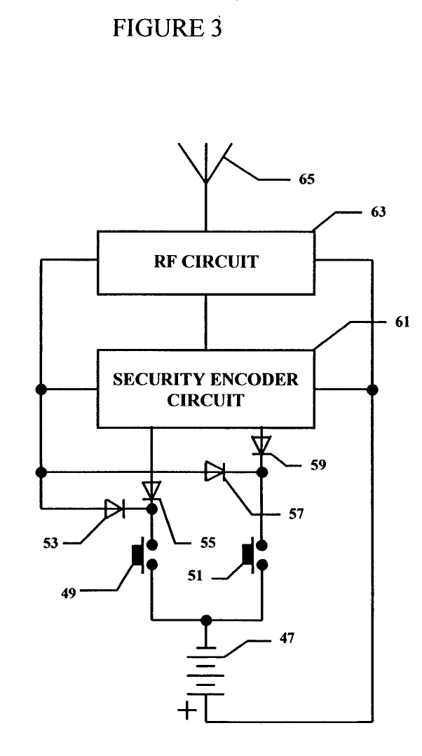

Switches 5 and 7 are the switches that activates the selected transmitter channel from one of a plurality of encoder channels, and operates the remote control transmitter 1 transmission output. These switches 5, 7 could be any thin switches such as conductive polymer, dome, or any other suitable thin switches, many of which are well known in the art. The Electronic Circuitry section 9 includes a system security encoder circuit 61, an RF frequency oscillator circuit 63 and transmitting driver circuit that drives antenna 65. (See FIG. 3 for some of these details.) Antenna 65 is shown as a trace 11 etched or plated on the printed circuit board 13. Antenna, 11, could also be a short wire antenna, an etched plated trace antenna that encircles the entire transmitter, a patch antenna that is etched or plated on printed circuit board, a slot antenna that is etched or plated on printed circuit board, a tuned wire or trace antenna, a single or multiple wire loop antenna that encompasses a small portion of the circuitry, or a single or multiple wire loop antenna that encircles the complete transmitter circuit (assembly) and/or battery, all with antenna, 11, completely embedded within the plastic encapsulation material of the credit card sized remote control transmitter.

Optional transponder circuit 15 is a complete transponder unit when connected to transponder loop coil 17. The transponder circuit 15 can operate if connected to the credit card sized remote control transmitter battery or not connected to the credit card sized remote control transmitter battery. It operates without the battery by drawing power from the incoming transponder power signal. Storing the power in a power storage capacitor, then using said stored power to transmit the programmed transponder signal to the ignition interrupt circuit. This would allow an operator to start a vehicle with a passive interrupt system while using a plain ignition key (key without a transponder) by holding the credit card sized remote control transmitter with a programmed transponder in near proximity to the ignition key while it is in the ignition and in the act of starting the vehicle.

Although not shown, electrical contacts can be integrated into the peripheral edge or near the edge of the credit card sized transmitter to complete a circuit to the battery allowing for recharging of the battery. Having contacts on external surface the credit card transmitter can require the use of isolation diodes to protect the battery from discharging if the transmitter is carried into water, particularly the ocean.

FIGS. 2A-2C show a second embodiment of the instant invention wherein a plastic credit card sized encapsulation material encloses or encapsulates the exterior of the entire device using any well known laminating, encapsulating, potting, or coating process to form of a credit card sized remote control transmitter 21 as described in the preferred embodiment. A plastic key 35 is built into the credit card sized transmitter 21. The transmitter encapsulation material encapsulates and forms a unitary package for all the internal sections of the transmitter 21 as shown in FIGS. 2A-2C. In the preferred embodiment, the credit card sized remote control transmitter with a key can be essentially the same size as a normal credit card (2⅛″ by 3⅜″) and of a thickness that is slightly greater than a normal credit card. The thickness of any location on the credit card sized remote control transmitter is not greater than 5/32″. For any embodiment of transmitter, 21, the width of the credit card transmitter with a key is not less than 2″ or greater than 3″. The length of the credit card transmitter with a key is not less than 3″ or greater than 5″.

Battery section, 23, is shown as a raised section of the transmitter where a thicker lithium battery could be installed. It is not necessary for this section to be raised if a thinner lithium battery is used. A printed battery could also be used and built into a printed circuit board 41 or the plastic encapsulation material. Also, any other thin battery with sufficient capacity could be used.

Switches, 25 and 27, are the switches that activates the selected transmitter channel from one of a plurality of encoder channels, and operates the remote control transmitter 21 transmission output. These switches could be any thin switches such a conductive polymer, dome, or any other suitable thin switches.

Section 29 includes a system security encoder circuit 61, a RF frequency oscillator circuit and transmitting driver circuit 63 that drives antenna 65. Again, antenna 65 is shown as a trace 31 etched or plated on the printed circuit board. The antenna 65 could alternatively be a short wire antenna, a single wire coil antenna, patch antenna, slot antenna, or multiple wire coil antenna. In any case, the antenna 65 can encircle the complete transmitter 21 and key assemblies with antenna 31 completely embedded inside the credit card sized remote control transmitter 21 encapsulation material.

Plastic key blank 35 can lay flat in the credit-card sized transmitter key recess 43 when not in use and then can be swung out on a hinge 45 to a position perpendicular to the plane of the card for keying and use.

In the preferred embodiment, the credit card sized transmitters 1, 21 comprise and are encapsulated in an encapsulation material that is indistinguishable from and unitary with the transmitter 1, 21 Again, in the preferred embodiment, the length and width dimensions of credit cards sized transmitter 1, 21 are identical to those of a conventional credit card. That is, the length is 3⅜ inches and the width is 2⅛ inches. The thickness is somewhat dependent on the elements that may protrude as shown in the elevation views of FIGS. 1B-1C and 2B-2C. However, the thickness dimensions of the preferred embodiments are less than or equal to 5/32 inch.

FIG. 3 is a block diagram of the internal electronics circuitry having typical RF transmitter components for a credit card sized remote control transmitters 1, 21 of the instant invention. The internal electronics circuitry has the transmitting circuit. The transmitting circuit is composed of an oscillator circuit and a driver circuit, many of which are well known in the art, which includes substantially all of the components except for the encoder unit 61. The particulars of the embodiment of FIG. 3 provide negative inputs to the encoder unit 61 and the entire circuit is not powered until one of the switches 49, 51 is depressed. Battery, 47, is shown as a 3 cell battery. However, in the preferred embodiment, the battery 47 is a one cell 3 volt lithium battery.

Switches 49, and 51 turn on the power and select the transmitter channel to be transmitted from the credit card sized remote control transmitters 1, 21. Diodes, 53, and supply power to the transmitter when either switch 49 or 51 is activated, or when both switches 49 and 51 are activated.

The diodes 53, 57 likewise isolate the power from the transmitting circuit when the switches 49, 51 are not actuated. Diodes 55 and 59 select the channel to be transmitted by supplying ground to the channel control inputs of encoder unit 61. Only when a diode is activated by a respective switch 49, 51, does it select the channel to be transmitted. The non-actuated switch thus isolates inputs from its corresponding diode 55, 59.

Other configurations of the transmitter internal electronics in the credit card sized remote control transmitters, 21 could be used. Many such configurations are well known in the art. Any of these could be used in credit card sized remote control transmitter 1, 21 as long as all of the parts are of a low profile (height) that could be integrally built into the plastic encapsulation material of credit card sized transmitter 1, that would fit in a wallet, purse or garment pocket.

For the embodiments of FIG. 3, the encoder unit circuits 61 can comprise a completely integrated circuit without any external components. The completely integrated circuit of the encoder unit circuits may comprise an integrated encoder with associated components for the local oscillator, pull-ups on inputs, and other components as required. Alternatively, the encoder unit circuits 61 can comprise a microcontroller with its associated components programmed to provide an encryption code. The encoder units 61 then normally supplies a digital pulse code to pulse modulate, amplitude modulate, or frequency modulate RF transmitting circuits 63.

Other encryption processes could also be used within credit card sized remote control transmitters 1, 21. The RF transmitting circuits 63 in the preferred embodiments comprises a SAW resonator or crystal to establish a stable RF oscillator frequency. As such, the RF oscillator may or may not be a part of the RF output driver circuit. Alternatively, RF transmitting circuits 63 could also employ a LC, SAW, or crystal frequency controlled completely RF integrated circuit chip solution. It is also possible for the encoder units 61 to be a part of this completely integrated circuit chip solution.

Antenna 65 is driven by the RF output driver of RF transmitter circuits 63. Antennas 65 in the preferred embodiment are traces on printed circuit boards. Other possibilities would include etched or plated antennas, wire antennas, wire loops, or multiple wire loops.

The credit card sized remote control transmitter can be made by providing the transmitter on a printed circuit board 13, 33 and encapsulating the printed circuit board 13, 33 in plastic encapsulation material. Other means may also be employed to encapsulate the RF transmitting circuits 63 within the plastic credit card size transmitter 1, 21.

The plastic key 35 is molded to fit a key hole of any of a variety of different vehicle manufacturers. The key material is strong enough to sustain repeated use without wearing out. The key 35 can be cut by a conventional key machine to match the owner's ignition key or door key.

As can be seen, the primary advantages of the credit card sized transmitter is that its small size enables ease of carrying, ease of accessing, and the convenience of a back-up remote control device when a primary remote control device fails, is misplaced, is inaccessibly locked in the vehicle, or is stolen. This additional convenience feature is provided by the back-up mechanical key 35. In use, if the normal key is not available for any reason, then the user has the option of accessing the back-up mechanical key 35 normally disposed in the recess of the credit card sized transmitter. The user removes the mechanical key 35 from the recess in a hinging fashion and inserts the mechanical key into a key hole in a conventional way to operate the locking mechanism. The mechanical key is thus used, for example, to start and operate a vehicle, disable a security system, or unlock a door.

Other configurations of the transmitter in credit card sized remote control transmitter, 1, could be used, almost all of which are well known in the art. Any of these could be used in credit card sized remote control transmitter, 1, as long as all of the parts are of a low profile (height) that could be used in a thin plastic or other material card that fits in a wallet, purse, or garment pocket. Some of the uses of the credit card sized remote control transmitter are as a loner remote control transmitter, or as a backup, emergency, or convenience remote control transmitter if the primary remote control transmitter fails, is lost, is misplaced, is inaccessibly locked in the vehicle, but the credit card sized remote control transmitter is not limited to these uses. It could also be used as the primary remote control transmitter as a convenience to the user in some applications. The credit card sized remote control transmitter could also be placed into a clear picture or credit card holder and accessed without removing the transmitter from its holder simply by depressing the buttons (user operable switches) through the clear holder material.

While the invention has been described with reference to a particular embodiment thereof, those skilled in the art will be able to make various modifications to the described embodiment of the invention without departing from the true spirit and scope thereof. It is intended that all combinations of elements perform substantially the same function in substantially the same way to achieve substantially the same result are within the scope of this invention

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

What is claimed is:

1. A credit card sized transmitter for transmitting a remote control signal that can be carried conveniently in a wallet, purse, or garment pocket, said credit card sized transmitter comprising:
a power source;
an encoder;
a transmitting circuit;
an antenna;
at least one user operable switch;
a printed circuit board;
an encapsulation material; and
said power source, said encoder, said transmitting circuit, said antenna, and said at least one user operable switch, printed circuit board, and encapsulation material integrally united and encapsulated in said credit card sized package for transmitting said remote control signal.

2. A credit card sized transmitter for transmitting a remote control signal that can be carried conveniently in a wallet, purse, or garment pocket, said credit card sized transmitter comprising:
a power source;
an encoder;
a transmitting circuit;
an antenna;
at least one user operable switch;
a printed circuit board;
an encapsulation material; and
a flexibly hinged mechanical key and;
a key-shaped recessed opening in the credit card material for storing said flexibly hinged mechanical key;
said power source, encoder, transmitting circuit, antenna, one or more user operable switches, printed circuit board, mechanical key, key-shaped recessed opening, and encapsulation material integrally united and encapsulated in said credit card sized package for transmitting said remote control signal; and
said mechanical key removably received and/or flexibly hinged in said recess and adapted for any conventional mechanical locking mechanism use.

3. A credit card sized transmitter for transmitting a remote control signal that can be carried conveniently in a wallet, purse, or garment pocket, said credit card sized transmitter comprising:
a power source;
an encoder;
a transmitting circuit;
an antenna;
at least one user operable switch;
a printed circuit board;
an encapsulation material; and
a flexibly hinged mechanical key and;
a key-shaped recessed opening in the credit card material for storing said flexibly hinged mechanical key;
a complete transponder unit;
said power source, encoder, transmitting circuit, antenna, one or more user operable switches, printed circuit board, key, key-shaped recessed opening, complete transponder unit, and encapsulation material integrally united and encapsulated in said credit card sized package for transmitting said remote control signal;
said mechanical key removably received and/or flexibly hinged in said recess opening and adapted for any conventional mechanical locking mechanism use; and said transponder unit, when programmed into the vehicle passive interrupt system, enables the passive interrupt system allowing the starting and operating of the vehicle when using a standard ignition key.

4. The credit card sized transmitter of claim 1, 2, or 3, said power source comprising: a battery.

5. The credit card sized transmitter of claim 1, 2, or 3, wherein:
said one or more user operable switches is one of a plurality of switches, and
said at least one user operable switch activates one of a plurality of channels in said encoder.

6. The credit card sized transmitter of claim 2, or 3, wherein:
said key is adapted to be keyed on a key cutting machine.

7. The credit card sized transmitter of claim 2, or 3, wherein:
said key is adapted to be used to operate the ignition and starting circuits of a vehicle

8. The credit card sized remote control transmitter of claim 1, 2, or 3, wherein: said credit card sized remote control transmitter has a length in the range of 3-5 inches and a width in the range of 2-3 inches; such that said credit card sized remote control transmitter does not take up much space, and can be stored in a location such as a wallet, purse, or garment pocket that is convenient, easy to remember, and readily accessible for use as a back-up transmitter in case a primary remote control transmitter fails, is misplaced, is lost, is stolen, or is inaccessibly locked in the vehicle.

9. The credit card sized remote control transmitter of claim 1, 2, or 3, wherein: said credit card sized remote control transmitter has a length of essentially 3⅜ inches and a width of essentially 2⅛ inches; such that said credit card sized remote control transmitter can be conveniently located in a wallet, purse, or garment pocket storage location having dimensions limited to receive a package having a length essentially no greater than 3½″ or a width essentially no greater than 2¼″.

10. The credit card sized remote control transmitter of claim 2, or 3, wherein: said credit card sized remote control transmitter has a thickness that is slightly greater than a normal credit card.

11. The credit card sized remote control transmitter of claim 1, wherein: said credit card sized remote control transmitter has a thickness that is less than, equal to, or slightly greater than a normal credit card.

12. The credit card sized transmitter of claim 1, 2, or 3, wherein:
said transmitting circuit comprises an RF oscillator and driver combination, and
said encoder comprises a built-in oscillator.

13. The credit card sized transmitter of claim 1, 2, or 3, wherein:
said transmitting circuit comprises an integrated circuit.

14. The credit card sized transmitter of claim 1, 2, or 3, wherein:
said transmitting circuit comprises a completely integrated circuit, and
said encoder is part of said completely integrated circuit.

15. The credit card sized transmitter of claim 1, 2, or 3, wherein: said oscillator comprises:
an LC, SAW, or crystal frequency controlled RF oscillator.

16. The credit card sized transmitter of claim 1, 2, or 3, wherein: said transmitting antenna is one of: an etched trace antenna, plated trace antenna, patch antenna, slot antenna, short wire antenna, wire loop antenna, a multiple wire loop antenna, or other type of etched or plated antenna.

17. The credit card sized transmitter of claim 1, 2, or 3, wherein said antenna encircles one or more of the encoder, the transmitting circuit, and the battery.

18. The credit card sized transmitter of claim 1, wherein:
said credit card sized transmitter has a length in the range of 2-5 inches and a width in the range of 1-3 inches; such that said credit card sized transmitter does not take up much space, and can be placed in a location that is easy to remember and readily accessible as a back-up transmitter in case a primary remote control transmitter fails, is misplaced, is stolen, or is inaccessibly locked inside the vehicle.

19. The credit card sized transmitter of claim 15, wherein:
said credit card sized transmitter has a length of substantially 3⅜ inches and a width of substantially 2⅛ inches; such that said credit card sized transmitter can be conveniently located in a wallet or pocket having dimensions limited to receive a package having a length substantially no greater than 3½ inches or a width substantially no greater than 2¼ inches.

20. The credit card sized transmitter of claim 1, wherein said credit card sized remote control transmitter also comprises,
a complete transponder unit;
said transponder unit, when programmed into the vehicle passive interrupt system, enables the passive interrupt system allowing the starting and operating of the vehicle when using a standard ignition key.
